(19) United States
(12) Patent Application Publication
(10) Pub. No.: US 2012/0141727 A1
(43) Pub. Date: Jun. 7, 2012

(54) SPORTBOARD

(76) Inventors: Shawn Goodsite, Riverside, CA (US); Chris Goodsite, Riverside, CA (US)

(21) Appl. No.: 12/959,324

(22) Filed: Dec. 2, 2010

(51) Int. Cl. B32B 3/10

(52) U.S. Cl. 428/131

(57) ABSTRACT

An improved sportboard includes a planar support platform that has a top surface, a bottom surface, a first end, a second end, a first side, a second side, a first predetermined thickness and first and second attachment features for wheel mounting trucks. The improvement includes at least one aperture. The aperture extends from the top surface to the bottom surface and is sized and shaped to permit insertion of either at least one finger of a user or a securing device. The aperture may have a beveled or curved edge for more comfortable carrying or may include a liner with an enhanced gripping surface. The apertures are positioned adjacent either side or either end of the sportboard. The sportboard may be formed of wood, plastic or other semi-rigid material. Mounting features are provided at either end of the sportboard for securing wheel trucks and mounted wheel sets to the sportboard.

### FIELD OF INVENTION

This invention relates to methods of transporting sporting equipment, and more specifically to devices for conveniently moving skateboards and similar devices.

### BACKGROUND OF THE INVENTION

Consumers commonly carry their sportboards by holding parts of the sports board that protrude from the actual product or by gripping the board in their hands as a means for carrying and/or transporting the sports-board.

Originally sportboards were not really meant to be carried and not meant to be secured (“locked”), but were meant to be ridden on—where the rider would stand on the sportboard and depending on the sport, the ride would propel himself or be moved by some other means such as gravity.

Over time, people have developed different ways to carry the board and protect the art on it. U.S. Pat. No. 5,132,883, issued to La Lumandier, discloses an illuminated railing for attachment to a skateboard as a bumper for protecting the bottom of the board or the ends thereof or the like. The railing is formed from a bar with externally viewable lights. The lights are connected to a circuit which includes a battery and a way to break the circuit. For use as a replacement part, the bar is preferably flexible and symmetrical to minimize the number of parts which must be stocked.

U.S. Pat. No. 4,103,917, issued to Widolf, describes a wheel housing is resiliently mounted on a skateboard truck base by means of a fastener which extends through the housing and is threaded onto a stud fixed to the base to compress a tubular cushion between the housing and the base. The fastener has a square cross-section which mates with a square bore in the cushion so that rotation of the fastener with respect to the cushion is prevented except when the retainer is manually forceably rotated to adjust the compression on the cushion. Typically, a rider would use the wheel housing to carry or transport the board when the sportboard was not being ridden.

U.S. Pat. No. 7,445,218, issued to Esposito, et al., illustrates a skateboard deck that includes a hole or cavity formed therein, which is filled with a clear, transparent, or translucent filler material that does not significantly alter the structural integrity of the deck. The filler material forms a window or a translucent insert in the deck. In one practical embodiment, an object (or objects) is located within the window or translucent insert. The object may be a decal corresponding to the brand, manufacturer, distributor, or retailer of the skateboard deck, an active electronic component, or any suitable feature, compound, apparatus, device, or material.

U.S. Pat. No. 7,669,879, issued to Dykema, discloses a high-strength skateboard deck includes an elongated body having opposite ends, opposite sides, an upper side and a lower side, the lower side including a plurality of embossments therein, improving the strength in the skateboard deck, reducing fatigue in the skateboard deck, and reducing the coefficient of friction of the lower side of the skateboard deck.

However, the inventions by Dykema, Esposito, et. al., are specifically created to support the inventions as a means to transport the user, whereas the present invention is created specifically to carry and transport and secure a sports-board.

It is an objective of the present invention to provide a convenient means for carrying a sportboard with a user's hand. It is a further objective to provide such means without interfering with the structural or decorative features of the board. It is still a further objective to provide a carrying means that is suitable for users with different size hands. Finally, it is an objective of the invention to provide a carrying and transport means for a sportboard that is durable, easy and inexpensive to manufacture.

While some of the objectives of the present invention are disclosed in the prior art, none of the inventions found include all of the requirements identified.

### SUMMARY OF THE INVENTION

The present invention addresses all of the deficiencies of prior art sportboard inventions and satisfies all of the objectives described above.

1) An improved sportboard providing the desired features may be constructed from the following components. A planar support platform is provided. The platform has a top surface, a bottom surface, a first end, a second end, a first side, a second side, a first predetermined thickness and first and second attachment features for wheel mounting trucks. The improvement includes at least one aperture. The aperture extends from the top surface to the bottom surface and is sized and shaped to permit insertion of either at least one finger of a user or a securing device.

2) In a variant of the invention, the at least one aperture is located adjacent either the first side or the second side.

3) In another variant, the at least one aperture is located adjacent either the first end or the second end.

4) In still another variant, the at least one aperture includes at least one beveled edge adjacent either the top or bottom surface, thereby providing additional comfort for a user carrying the sportboard by the aperture.

5) In yet another variant, the at least one aperture includes at least one curved edge adjacent either the top or bottom surface, thereby providing additional comfort for a user carrying the sportboard by the aperture.

6) In a further variant, the at least one aperture includes a liner. The liner is formed of resilient material and provides an improved gripping surface.

7) In a final variant, the resilient material selected from the group that includes rubber, plastic and wood.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of the preferred embodiment of the invention including carrying apertures adjacent the first side;

FIG. 2 is a plan view of the FIG. 1 embodiment;

FIG. 3 is a bottom view of the FIG. 1 embodiment;

FIG. 4 is a partial perspective cross-sectional view of the FIG. 1 embodiment taken along the line 4-4;

FIG. 5 is a plan view of a second embodiment illustrating carrying apertures adjacent the first end;

FIG. 6 is a partial perspective cross-sectional view of the FIG. 5 embodiment taken along the line 5-5; and

FIG. 7 of the FIG. 1 embodiment illustrating apertures of an alternative shape.

### DETAILED DESCRIPTION OF THE PREFERRED EMBODIMENT

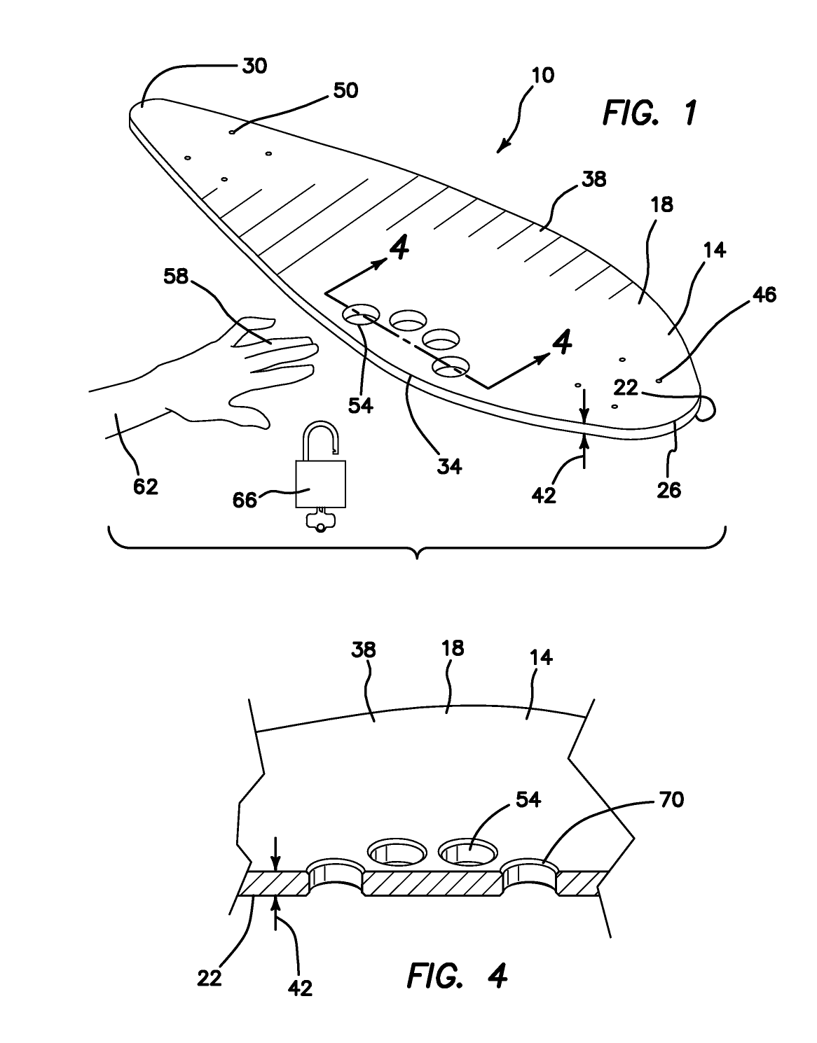

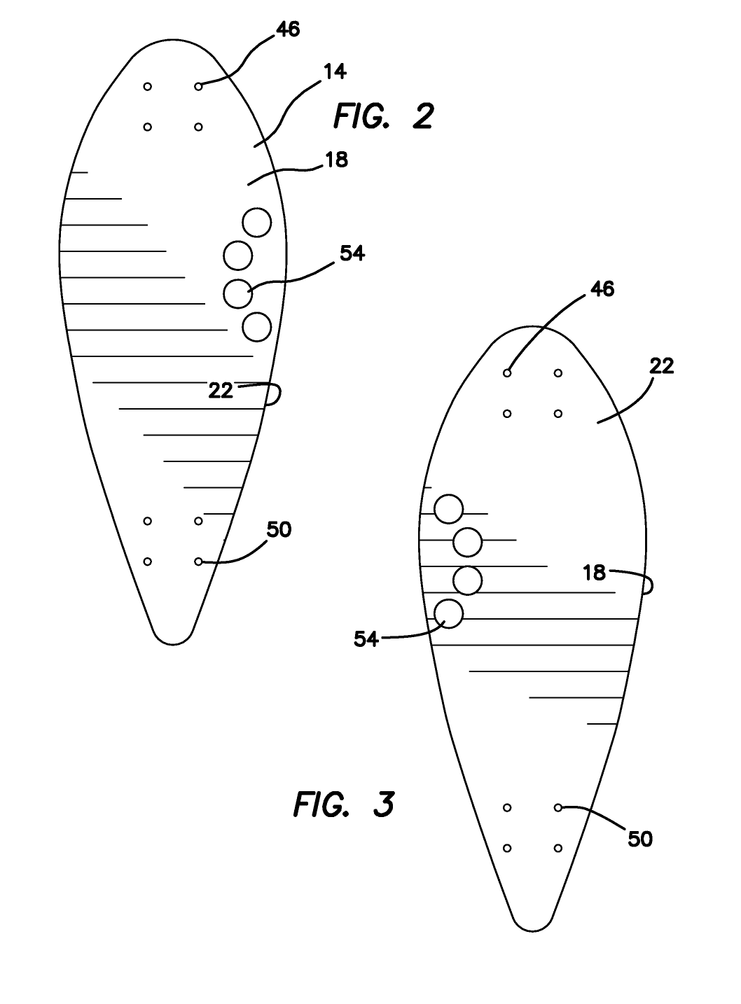

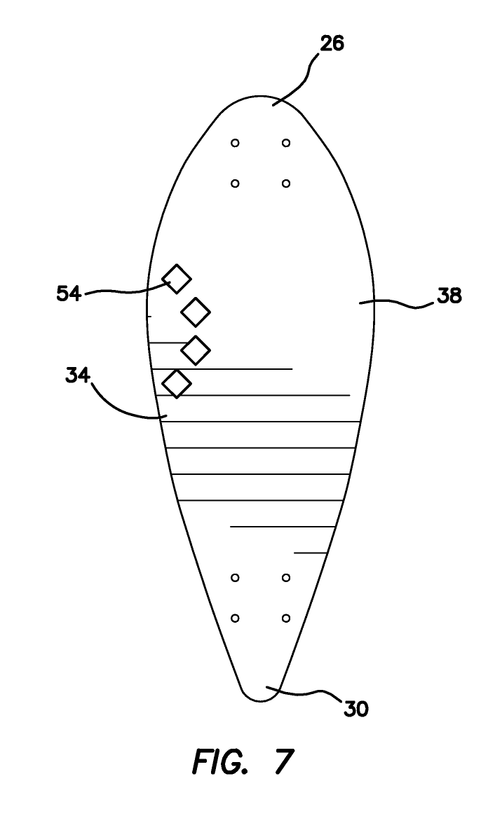

1) FIGS. 1-7 illustrate an improved sportboard 10 providing the desired features that may be constructed from the following components. A planar support platform 14 is provided. The platform 14 has a top surface 18, a bottom surface 22, a first end 26, a second end 30, a first side 34, a second side 38, a first predetermined thickness 42 and first 46 and second 50 attachment features for wheel mounting trucks (not shown). The improvement includes at least one aperture 54. The aperture 54 extends from the top surface 18 to the bottom surface 22 and is sized and shaped to permit insertion of either at least one finger 58 of a user 62 or a securing device 66.

2) In a variant of the invention, as illustrated in FIGS. 1-4 and 7, the at least one aperture 54 is located adjacent either the first side 34 or the second side 38.

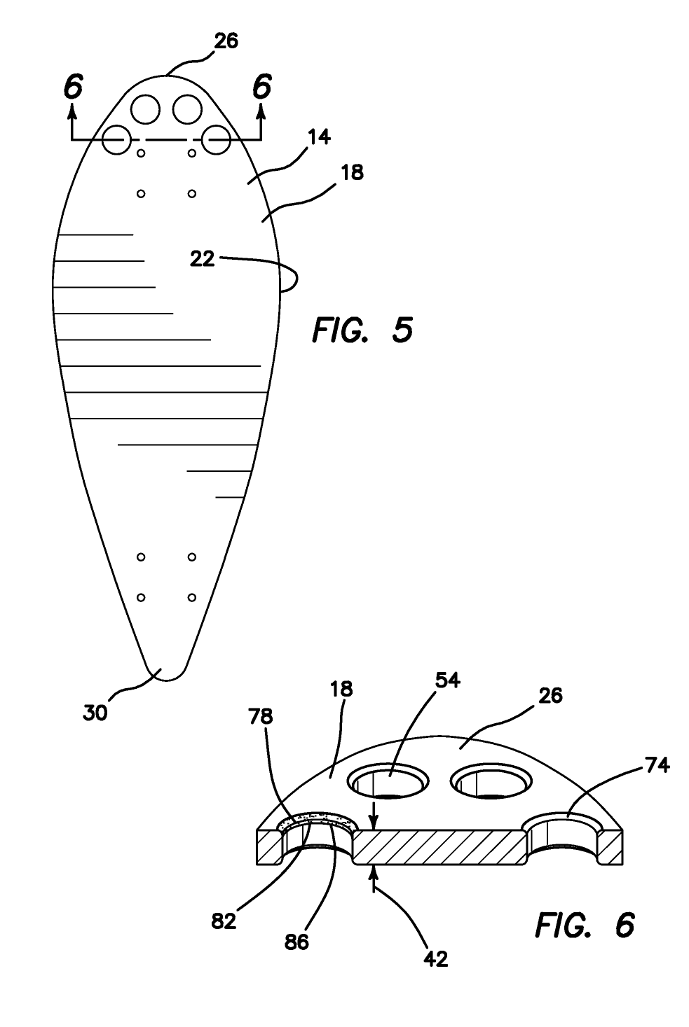

3) In another variant, as illustrated in FIGS. 5 and 6, the at least one aperture 54 is located adjacent either the first end 26 or the second end 30.

4) In still another variant, as illustrated in FIG. 4, the at least one aperture 54 includes at least one beveled edge 70 adjacent either the top 18 or bottom 22 surface, thereby providing additional comfort for a user 62 carrying the sportboard 10 by the aperture 54.

5) In yet another variant, as illustrated in FIG. 6, the at least one aperture 54 includes at least one curved edge 74 adjacent either the top 18 or bottom 22 surface, thereby providing additional comfort for a user 62 carrying the sportboard 10 by the aperture 54.

6) In a further variant, the at least one aperture 54 includes a liner 78. The liner 78 is formed of resilient material 82 and provides an improved gripping surface 86.

7) In a final variant, the resilient material 82 is selected from the group that includes rubber, plastic and wood.

The improved sportboard 10 has been described with reference to particular embodiments. Other modifications and enhancements can be made without departing from the spirit and scope of the claims that follow.

1. An improved sportboard of the type comprising a planar support platform, said platform having a top surface, a bottom surface, a first end, a second end, a first side, a second side, a first predetermined thickness and first and second attachment features for wheel mounting trucks, the improvement comprising:
at least one aperture, said aperture extending from said top surface to said bottom surface and being sized and shaped to permit insertion of either of at least one finger of a user and a securing device.

2. The improved sportboard, as described in claim 1, wherein said at least one aperture is disposed adjacent either of said first side and said second side.

3. The improved sportboard, as described in claim 1, wherein said at least one aperture is disposed adjacent either of said first end and said second end.

4. The improved sportboard, as described in claim 1, wherein said at least one aperture further comprises at least one beveled edge adjacent either of said top surface and said bottom surface, thereby providing additional comfort for a user carrying said sportboard by said aperture.

5. The improved sportboard, as described in claim 1, wherein said at least one aperture further comprises at least one curved edge adjacent either of said top surface and said bottom surface, thereby providing additional comfort for a user carrying said sportboard by said aperture.

6. The improved sportboard, as described in claim 1, wherein said at least one aperture further comprises a liner, said liner being formed of resilient material and providing an improved gripping surface.

7. The improved sportboard, as described in claim 6, wherein said liner is formed of resilient material selected from the group comprising:
rubber, plastic and wood.
